(19) United States
(12) Patent Application Publication
(10) Pub. No.: US 2026/0275093 A1
(43) Pub. Date: Sep. 17, 2026

(54) RUBBER COMPOSITION

(71) Applicant: Compagnie Generale Des Etablissements Michelin, Clermont-Ferrand (FR)

(72) Inventor: Etienne FLEURY, Clermont-Ferrand (FR)

(73) Assignee: Compagnie Generale Des Etablissements Michelin, Clermont-Ferrand (FR)

(21) Appl. No.: 19/479,868

(22) PCT Filed: Apr. 18, 2024
(86) PCT No.: PCT/EP2024/060543

§ 371 Date: Oct. 29, 2025

(30) Foreign Application Priority Data
May 4, 2023 (FR) FR2304462

(51) Int. Cl. C08L 23/0807; B60C 1/00; C08K 3/04; C08K 3/06; C08K 3/22; C08K 5/01; C08K 5/09; C08K 5/18; C08K 5/47

(52) U.S. Cl. CPC C08L 23/083; B60C 1/0016; C08K 3/04; C08K 3/06; C08K 5/01; C08K 5/09; C08K 5/18; C08K 5/47; C08K 2003/2296

(57) ABSTRACT

A rubber composition comprising more than 90 phr of a highly saturated diene elastomer that is a copolymer of ethylene and 1,3-butadiene is provided. The rubber composition contains more than 50 mol % of ethylene units, between 30 phr and 55 phr of a reinforcing filler that comprises more than 90% by weight of a carbon black, a vulcanization system and a content of less than 3 phr of a polyalkylene glycol bearing a hydroxy function at either end of the polymer chain. The polyalkylene glycol is a homopolymer of ethylene glycol or propylene glycol or a copolymer of ethylene glycol and propylene glycol. The composition has improved crack propagation resistance properties.

### CROSS REFERENCE TO RELATED APPLICATIONS

This U.S. patent application is a national phase entry of PCT Patent Application No. PCT/EP2024/060543, filed Apr. 18, 2024, which claims priority to French Patent Application No. FR 2304462, filed May 4, 2023, the entire contents of which are incorporated herein by reference in their entirety.

### BACKGROUND

### 1. Technical Field

The field of the present invention is that of rubber compositions reinforced with a carbon black and rich in a highly saturated diene elastomer. These rubber compositions are intended in particular for use in a tyre.

### 2. Related Art

In rubber compositions for tires it is known to use copolymers having a lower sensitivity to oxidation, for example highly saturated diene elastomers such as copolymers of ethylene and 1,3-butadiene that contain more than 50 mol % of ethylene units. The use of such copolymers of ethylene and of 1,3-butadiene in a tire tread is described for example in document WO 2014114607 A1 and has the effect of giving the tire an improved trade-off in performance between rolling resistance and wear resistance. It is likewise known to use such copolymers in the treads of aircraft tires to increase wear resistance at high speed, as is described for example in document WO 2016012259 A1.

It is also important for rubber compositions to be available that have good cohesion, in particular good resistance to crack propagation. Specifically, when running, a tire tread is subjected to mechanical stresses and to attacks resulting from direct contact with the ground. This results in the creation of crack initiation sites. In the course of their propagation on the surface or in the interior of the tread, crack initiation sites can result in damage to the material that makes up the tread. This tread damage reduces the service life of the tire tread. The mechanical stresses and attacks to which the tire is subjected are amplified under the effect of the weight borne by the tire; consequently, good cohesion is particularly important for a composition intended to be used as a tread of a tire fitted to a vehicle carrying heavy loads, such as a tire for heavy-duty vehicles or civil engineering vehicles. To increase the resistance to crack propagation of a rubber composition reinforced with a carbon black and containing such a highly saturated diene elastomer, the applicant has described in document WO 2020053520 A1 the use in the rubber composition of sulfur in low contents, in particular contents of less than 1 phr.

### SUMMARY

In the course of its work, the applicant has developed a novel rubber composition rich in a highly saturated diene elastomer and reinforced primarily with a carbon black also having good crack propagation resistance properties.

The invention accordingly firstly provides a rubber composition comprising more than 90 phr of a highly saturated diene elastomer that is a copolymer of ethylene and 1,3-butadiene and that contains more than 50 mol % of ethylene units, between 30 phr and 55 phr of a reinforcing filler that comprises more than 90% by weight of a carbon black, a vulcanization system and a content of less than 3 phr of a polyalkylene glycol bearing a hydroxy function at either end of the polymer chain, the polyalkylene glycol being a homopolymer of ethylene glycol or propylene glycol or a copolymer of ethylene glycol and propylene glycol.

The invention also provides a tire comprising a tread in which the portion intended to be in contact with the road surface consists wholly or partly of a rubber composition according to the invention.

### DETAILED DESCRIPTION OF EXAMPLE EMBODIMENTS

Any interval of values denoted by the expression “between a and b” represents the range of values greater than “a” and less than “b” (i.e. limits a and b excluded), whereas any interval of values denoted by the expression “from a to b” means the range of values extending from “a” up to “b” (i.e. including the strict limits a and b).

The abbreviation “phr” means parts by weight per hundred parts of elastomer (of the total of the elastomers if a plurality of elastomers is present).

The compounds mentioned in the description may be of fossil origin or may be biobased. In the latter case, they may be partially or completely derived from biomass or obtained from renewable raw materials derived from biomass. In the same way, the compounds mentioned may also originate from the recycling of already-used materials, i.e. they may partially or completely result from a recycling process, or else be obtained from raw materials that themselves result from a recycling process.

In the present invention, a “tire” is understood as meaning a pneumatic or non-pneumatic tire. A pneumatic tire usually comprises two beads intended to come into contact with a rim, a crown composed of at least one crown reinforcement and a tread, and two sidewalls, the tire being reinforced by a carcass reinforcement anchored in the two beads. A non-pneumatic tire on the other hand usually comprises a base, designed for example for mounting on a rigid rim, a crown reinforcement ensuring the connection with a tread, and a deformable structure, such as spokes, ribs or cells, this structure being arranged between the base and the crown. Such non-pneumatic tires do not necessarily include a sidewall. Non-pneumatic tires are described for example in documents WO 03/018332 and FR2898077. According to any of the embodiments of the invention, the tire according to the invention is preferably a pneumatic tire.

Unless otherwise stated, the contents of the units resulting from the insertion of a monomer into a copolymer such as the highly saturated diene elastomer that is useful for the purposes of the invention are expressed as molar percentages relative to the totality of the monomer units of the copolymer.

The highly saturated diene elastomer that is useful for the purposes of the invention is a copolymer of ethylene and 1,3-butadiene, preferably a statistical copolymer. The monomer units of the copolymer are ones resulting from the copolymerization of ethylene and 1,3-butadiene. The copolymer thus contains ethylene units and butadiene units. As is known, an ethylene unit is a monomer unit of structure —(CH₂—CH₂)—. As is also known, a butadiene unit is a monomer unit of structure —CH₂—CH(CH═CH₂)— (1,2 unit) or —CH₂—CH═CH—CH₂— (1,4 unit). The highly saturated diene elastomer contains more than 50 mol % of ethylene units.

The highly saturated diene elastomer comprises preferably at least 60 mol % of ethylene units, more preferably at least 65 mol % of ethylene units. In other words, the ethylene units preferably represent at least 60 mol % of all of the monomer units of the highly saturated diene elastomer, more preferably at least 65 mol % of all of the monomer units of the highly saturated diene elastomer. Preferably, the ethylene units represent at most 80 mol % of all of the monomer units of the highly saturated diene elastomer. More preferably, the ethylene units represent at most 75 mol % of all of the monomer units of the highly saturated diene elastomer. The highly saturated diene elastomer advantageously comprises from 60 mol % to 80 mol % of ethylene units, particularly from 60 mol % to 75 mol % of ethylene units, more particularly from 65 mol % to 75 mol % of ethylene units, the molar percentage being calculated based on all of the monomer units of the highly saturated diene elastomer.

The highly saturated diene elastomer can be obtained according to various synthesis methods known to those skilled in the art, in particular on the basis of the sought microstructure of the highly saturated diene elastomer. Generally, it can be prepared by copolymerization of 1,3-butadiene and ethylene and according to known synthesis methods, in particular in the presence of a catalyst system comprising a metallocene complex. These include catalyst systems based on metallocene complexes; such catalyst systems are described in patent applications EP 1 092 731, WO 2004035639, WO 2007054223 and WO 2007054224 in the name of the applicant. The highly saturated diene elastomer, including when it is statistical, can also be prepared by a process using a catalyst system of preformed type, such as those described in patent applications WO 2017093654 A1, WO 2018020122 A1 and WO 2018020123 A1. The highly saturated diene elastomer is advantageously statistical and is prepared preferably by a semi-continuous or continuous process as described in patent applications WO 2017103543 A1, WO 201713544 A1, WO 2018193193 and WO 2018193194.

The highly saturated diene elastomer preferably contains units of formula (I) or units of formula (II), 1,2 unit.

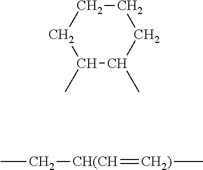

The presence of a saturated 6-membered cyclic unit, a 1,2-cyclohexane unit, of formula (I) in the copolymer can result from a series of very specific insertions of ethylene and 1,3-butadiene into the polymer chain during chain growth. When the highly saturated diene elastomer comprises units of formula (I) or units of formula (II), the molar percentages of the units of formula (I) and of the units of formula (II) in the highly saturated diene elastomer, respectively o and p, preferably satisfy the following equation (eq. 1) or the equation (eq. 2), o and p being calculated on the basis of all of the monomer units of the highly saturated diene elastomer.

$$0 < o + p \leq 30 \qquad ( eq . 1 )$$

$$0 < o + p < 25 \qquad ( eq . 2 )$$

Preferably, the highly saturated diene elastomer comprises units of formula (I) in a molar content of greater than 0 mol % and less than 15 mol %, more preferably less than 10 mol %, the molar percentage being calculated based on all of the monomer units of the highly saturated diene elastomer.

According to a particularly preferable embodiment, the highly saturated diene elastomer contains 1,4 units of trans configuration (1,4-trans units). When the diene elastomer contains 1,4-trans units, the 1,4-trans units represent more than 50 mol % of the 1,4 units of the highly saturated diene elastomer, preferably more than 80 mol % of the 1,4 units of the highly saturated diene elastomer.

The highly saturated diene elastomer may consist of a mixture of highly saturated diene elastomers that differ from one another in their microstructures or their macrostructures.

The content of the highly saturated diene elastomer in the rubber composition is greater than 90 parts by weight per hundred parts of elastomer of the rubber composition (phr). Where the highly saturated diene elastomer consists of a mixture of highly saturated diene elastomers that differ from one another in their microstructures or their macrostructures, the content of the highly saturated diene elastomer in the rubber composition refers to the mixture of highly saturated diene elastomers.

In addition to the highly saturated diene elastomer, the rubber composition may contain a second diene elastomer in a content by weight of less than 10 phr. A diene elastomer is understood as meaning an elastomer consisting at least in part (i.e. a homopolymer or a copolymer) of diene monomer units (monomers having two conjugated or non-conjugated carbon-carbon double bonds). The second elastomer may be selected from the group of highly unsaturated diene elastomers consisting of polymers containing 1,3-butadiene units or isoprene units, such as polybutadienes, butadiene copolymers and isoprene copolymers. A highly unsaturated diene elastomer refers to an elastomer that contains more than 50 mol % of diene units.

The content of the highly saturated diene elastomer in the rubber composition is preferably greater than 95 phr, advantageously equal to 100 phr.

The rubber composition comprises any type of “reinforcing” filler known for its abilities to reinforce a rubber composition employable in particular for the production of a tire tread. Such a reinforcing filler typically consists of nanoparticles, the (weight-) average size of which is less than a micrometre, generally less than 500 nm, most commonly between 20 and 200 nm, in particular and more preferably between 20 and 150 nm. The content of reinforcing filler is between 30 phr and 55 phr, preferably ranges from 35 phr to 50 phr, more preferably ranges from 35 phr to 45 phr.

The essential feature of the reinforcing filler is that it contains more than 90% by weight of a carbon black, percentage by weight being calculated relative to the weight of the reinforcing filler of the rubber composition. Preferably, the content by weight of the carbon black is greater than 95% of the weight of the reinforcing filler. When the content by weight of carbon black in the rubber composition is less than 100% of the weight of the reinforcing filler, the reinforcing filler may therefore comprise any type of filler other than carbon black that is also known for its abilities to reinforce a rubber 30 composition employable for the production of tires, for example a reinforcing inorganic filler such as silica combined with a coupling agent in a known manner. The content by weight of the carbon black is advantageously equal to 100% of the weight of the reinforcing filler. When carbon black is the sole reinforcing filler in the rubber composition, the desired technical effect is greater.

Suitable carbon blacks include all reinforcing carbon blacks, in particular the blacks conventionally used in tires or their treads (known as tire-grade blacks). The latter include more particularly the reinforcing carbon blacks of the 100, 200 and 300 series, or the blacks of the 500, 600 or 700 series (ASTM grades), for example the N115, N134, N234, N326, N330, N339, N347, N375, N550, N683 and N772 blacks. The carbon black may also be a mixture of carbon blacks, in which case the content by weight of carbon black relates to the mixture of carbon blacks. When the rubber composition according to the invention is used in a tread, the carbon black is preferably a carbon black of the 100 or 200 series.

Preferably, the carbon black has a BET specific surface area of greater than 90 m²/g. More preferably, the BET specific surface area of the carbon black is greater than 100 m²/g. Preferably, the carbon black has a BET specific surface area of less than 145 m²/g. The carbon black more preferably has a BET specific surface area of less than 130 m²/g.

The BET specific surface area is typically measured according to standard ASTM D6556-09 [multipoint method (5 points)—gas: nitrogen—relative pressure range P/P0: 0.05 to 0.30].

Another essential feature of the rubber composition is that it contains a polyalkylene glycol in a content of less than 3 phr, the polyalkylene glycol being a homopolymer of ethylene glycol or propylene glycol or a copolymer of ethylene glycol and propylene glycol. As is known, a polyalkylene glycol is an oxyalkylene polymer bearing a hydroxy (OH) function at either end of the polymer chain. Preferably, the polyalkylene glycol is a polyethylene glycol, a homopolymer of ethylene oxide bearing a hydroxy (OH) function at either end of the polymer chain.

The polyalkylene glycol content in the rubber composition is less than 3 phr, preferably less than 2 phr. A higher level of polyalkylene glycol does not bring an additional improvement in crack propagation resistance properties. This is why a content of less than 2 phr is advantageous from the point of view of the trade-off between the properties of the rubber composition and its cost. Preferably, the polyalkylene glycol content in the rubber composition is greater than 0.2 phr. The content of polyalkylene glycol in the rubber composition is advantageously greater than 0.2 phr and less than 2 phr.

The polyalkylene glycol that is useful for the purposes of the invention preferably has a weight-average molar mass of between 2000 and 20 000 g/mol, preferably between 5000 and 10 000 g/mol. The polyalkylene glycol that is useful for the purposes of the invention is generally a commercially available product, such as “Carbowax” PEG 8000 from Dow Corning.

The rubber composition may also include all or some of the customary additives commonly used in elastomer compositions intended for use in treads, for example crosslinking agents, pigments, protective agents, such as anti-ozone waxes, chemical antiozonants and antioxidants.

The rubber composition contains a vulcanization system. The vulcanization system typically comprises sulfur and a vulcanization accelerator.

The sulfur is typically provided in the form of molecular sulfur or a sulfur donor, preferably in molecular form. Sulfur in molecular form is also referred to as molecular sulfur. A sulfur donor is understood as meaning any compound that releases sulfur atoms, optionally combined in the form of a polysulfide chain, that are capable of being inserted into the polysulfide chains formed during vulcanization and bridging the elastomer chains. The sulfur content in the rubber composition is preferably less than 2 phr, preferably between 0.3 and 1.5 phr. According to any of the embodiments of the invention, the sulfur content is advantageously less than 1 phr.

It is possible to use as a (primary or secondary) vulcanization accelerator any compound capable of acting as an accelerator of the vulcanization of diene elastomers in the presence of sulfur, in particular accelerators of the thiazole type and also derivatives thereof, accelerators of sulfenamide type in the case of primary accelerators, or accelerators of guanidine, thiuram, dithiocarbamate, dithiophosphate, thiourea and xanthate type in the case of secondary accelerators. A guanidine is understood as meaning any compound that contains the divalent radical —HN—C(═NH)—NH—. The guanidine is preferably diphenylguanidine. The vulcanization accelerator is used in a content preferably of between 0.3 and 5 phr, more preferably of between 0.5 and 2.5 phr. According to any one of the embodiments of the invention, the content of vulcanization accelerator is advantageously less than 1 phr.

Examples of primary accelerators include in particular sulfenamide compounds such as N-cyclohexyl-2-benzothiazolesulfenamide (CBS), N,N-dicyclohexyl-2-benzothiazolesulfenamide (DCBS), N-tert-butyl-2-benzothiazolesulfenamide (TBBS) and mixtures of these compounds. The primary accelerator is preferably a sulfenamide, more preferably N-cyclohexyl-2-benzothiazolesulfenamide.

Examples of secondary accelerators include in particular thiuram polysulfides, preferably thiuram disulfides such as tetraethylthiuram disulfide, tetrabutylthiuram disulfide (TBTD), tetrabenzylthiuram disulfide (TBZTD) and mixtures of these compounds. The secondary accelerator is preferably a thiuram disulfide, more preferably tetrabenzylthiuram disulfide.

The vulcanization accelerator is preferably a sulfenamide. When the vulcanization accelerator is a sulfenamide, it is preferably N-cyclohexyl-2-benzothiazolesulfenamide.

As is known, the vulcanization system may also comprise vulcanization activators, for instance metal oxides such as zinc oxide or fatty acids such as stearic acid.

The rubber composition may be produced in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., a finishing phase during which the sulfur or the sulfur donor and the vulcanization accelerator are incorporated.

By way of example, the (non-productive) first phase is carried out in a single thermomechanical step during which all the necessary constituents, the optional supplementary processing aids and various other additives with the exception of the sulfur and the vulcanization accelerator are introduced into a suitable mixer, such as a standard internal mixer. The total kneading time in this non-productive phase is preferably between 1 and 15 min. After cooling the mixture thus obtained during the first, non-productive phase, the sulfur and the vulcanization accelerator are then incorporated at low temperature, generally in an external mixer such as an open mill; everything is then mixed (productive phase) for a few minutes, for example between 2 and 15 min.

Preferably, the rubber composition is extruded to form all or part of a tread profile of a tire. Then, during the assembly of a tire usually comprising, radially from the outside inwards, a tread, a crown reinforcement and a carcass reinforcement, the tread is laid radially outside the crown reinforcement. As is known, radially means in a radial direction in relation to the axis of rotation of the tire.

The tire may be in raw form (i.e. before the step of curing the tire) or in cured form (i.e. after the step of curing the tire). The tire is preferably a tire for a vehicle carrying heavy loads, in particular a tire for a heavy-duty vehicle or a tire for a civil engineering vehicle, preferably a tire for a heavy-duty vehicle.

To sum up, the invention can be implemented according to any one of the following embodiments 1 to 19:
Embodiment 1: Rubber composition comprising more than 90 phr of a highly saturated diene elastomer that is a copolymer of ethylene and 1,3-butadiene and that contains more than 50 mol % of ethylene units, between 30 phr and 55 phr of a reinforcing filler that comprises more than 90% by weight of a carbon black, a vulcanization system and a content of less than 3 phr of a polyalkylene glycol bearing a hydroxy function at either end of the polymer chain, the polyalkylene glycol being a homopolymer of ethylene glycol or propylene glycol or a copolymer of ethylene glycol and propylene glycol.
Embodiment 2: Rubber composition according to embodiment 1, wherein the highly saturated diene elastomer comprises at least 60 mol % of ethylene units.
Embodiment 3: Rubber composition according to embodiment 1 or 2, wherein the highly saturated diene elastomer comprises at least 65 mol % of ethylene units.
Embodiment 4: Rubber composition according to any one of embodiments 1 to 3, wherein the highly saturated diene elastomer comprises at most 80 mol % of ethylene units.
Embodiment 5: Rubber composition according to any one of embodiments 1 to 4, wherein the highly saturated diene elastomer comprises at most 75 mol % of ethylene units.
Embodiment 6: Rubber composition according to any one of embodiments 1 to 5, wherein the highly saturated diene elastomer contains units of formula (I), preferably in a molar content greater than 0% and less than 15%.

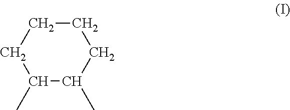

Embodiment 7: Rubber composition according to any one of embodiments 1 to 6, wherein the highly saturated diene elastomer is a statistical copolymer.
Embodiment 8: Rubber composition according to any one of embodiments 1 to 7, wherein the content of polyalkylene glycol is less than 2 phr.
Embodiment 9: Rubber composition according to any one of embodiments 1 to 8, wherein the content of polyalkylene glycol is greater than 0.2 phr.
Embodiment 10: Rubber composition according to any one of embodiments 1 to 9, wherein the polyalkylene glycol is a polyethylene glycol.
Embodiment 11: Rubber composition according to any one of embodiments 1 to 10, wherein the content of reinforcing filler ranges from 35 phr to 50 phr.
Embodiment 12: Rubber composition according to any one of embodiments 1 to 11, wherein the content of reinforcing filler ranges from 35 phr to 45 phr.
Embodiment 13: Rubber composition according to any one of embodiments 1 to 12, wherein the carbon black represents more than 95% by weight of the reinforcing filler.
Embodiment 14: Rubber composition according to any one of embodiments 1 to 13, wherein the carbon black represents 100% by weight of the reinforcing filler.
Embodiment 15: Rubber composition according to any one of embodiments 1 to 14 wherein the polyethylene glycol has a weight-average molar mass of between 2000 and 20 000 g/mol.
Embodiment 16: Rubber composition according to any one of embodiments 1 to 15, wherein the polyalkylene glycol has a weight-average molar mass of between 5000 and 10 000 g/mol.
Embodiment 17: Rubber composition according to any one of embodiments 1 to 16, wherein the content of the highly saturated diene elastomer is greater than 95 phr.
Embodiment 18: Rubber composition according to any one of embodiments 1 to 17, wherein the content of the highly saturated diene elastomer is equal to 100 phr.
Embodiment 19: Tire comprising a tread in which the portion intended to be in contact with the road surface consists wholly or partly of a rubber composition as defined in any one of embodiments 1 to 18.

The abovementioned features of the present invention, and also others, will be understood more clearly on reading the following description of several exemplary embodiments of the invention, which are provided by way of illustration.

### EXAMPLES

### Determination of the Microstructure of the Elastomers by Nuclear Magnetic Resonance (NMR):

The copolymers of ethylene and 1,3-butadiene are characterized by ¹H and ¹³C NMR spectrometry. The NMR spectra are recorded on a Bruker Avance III HD 500 MHZ spectrometer equipped with a 5 mm Z-gradient BBI broadband cryoprobe. The quantitative 1H NMR experiment uses a simple 30° pulse sequence and a repetition time of 5 seconds between each acquisition. 64 to 256 accumulations are carried out. The quantitative ¹³C NMR experiment uses a 30° single pulse sequence with proton decoupling and a repetition time of 10 seconds between each acquisition. 1024 to 10240 accumulations are carried out. ¹H/¹³C two-dimensional experiments are used for the purpose of determining the structure of the polymers. The determination of the microstructure of the copolymers is defined in the literature, according to the paper by Llauro et al., Macromolecules, 2001, 34, 6304-6311.

The NMR measurements are carried out at 25° C. The copolymers are dissolved in a deuterated solvent (about 25 mg of elastomer in 1 mL), generally deuterated chloroform (CDCl₃).

### Glass Transition Temperature of the Polymers:

The glass transition temperature (Tg) is measured using a differential scanning calorimeter according to standard ASTM D3418 (1999).

### Mooney Viscosity:

The Mooney viscosity is measured using an oscillating consistometer as described in standard ASTM D1646 (1999). The measurement is carried out according to the following principle: the sample, analysed in the uncured state (i.e. before curing), is moulded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. The Mooney viscosity (ML) is expressed in “Mooney units” (MU, where 1 MU=0.83 newton-metres).

### Size-Exclusion Chromatography (SEC/RI):

Size-exclusion chromatography (SEC) permits the fractionation of polymer chains in a solvent according to their hydrodynamic volume. Like all chromatographic systems, the technique is based on the elution of a solute (the polymer) through a column containing a stationary phase. The system is composed, in this order, of: a solvent reservoir, a pump system, an injector, a set of columns and detectors. The measurement system is equipped with a Waters Alliance e2695 module and a Waters fRI410 refractometer.

The mobile phase is eluted at a flow rate of 1 mL/min. The polymer is dissolved in THF at a concentration of 1 g/L. A volume of 100 μL is injected through a set of three size-exclusion chromatography columns of Agilent brand (Mixed B LS). The columns are thermostatically maintained at 35° C. in an oven. The stationary phase of the columns is based on a polystyrene/divinylbenzene gel having a controlled porosity. The polymer chains are separated according to the hydrodynamic volume that they occupy when dissolved in the solvent. The greater the volume they occupy, the less the pores of the columns are accessible to them, and the shorter their elution time. Detection is performed by a refractometer (RI) thermostatically maintained at 35° C. Each elution volume is associated with a mass via Moore calibration (calibrating against certified standards: polystyrene standards from Polymer Standard Service (Mainz)). The Waters Empower software is used for data acquisition and analysis. It is thus possible to determine the number-average molar masses (Mn), the weight-average molar masses (Mw), and also the dispersity (Ð=Mw/Mn).

### Mechanical Resistance in the Presence of a Crack Initiator (Tear Strength):

The tearability strength and deformation are measured on a test specimen drawn at 375 mm/minute to bring about breakage of the test specimen. The tensile test specimen consists of a parallelepiped-shaped rubber plate 2.5 mm thick, 84 mm long and 10 mm wide. Before starting the test, three very fine 3 mm long cuts are made using a razor blade, halfway along the length and aligned with the width of the test specimen. The force (N/mm) to be exerted to obtain breakage is determined and the elongation at break is measured. The energy needed to cause breakage (tear strength) of the test specimen, which is the product of the force and the elongation at break, can be determined. The test was performed in air, at a temperature of 100° C. High values are a measure of the rubber composition having good cohesion despite the presence of crack initiation sites.

### Reinforcing Properties:

The tensile tests make it possible to determine the elasticity stresses and the properties at break. Unless otherwise stated, they are based on the French standard NFT 46-002.

Processing the tensile test recordings makes it possible to plot the curve of modulus as a function of the elongation. The modulus used here is the nominal (or apparent) secant modulus measured in first elongation, calculated by normalizing to the initial cross section of the test specimen. The nominal secant moduli (or apparent stresses, in MPa) are measured in first elongation at 100% and 300% elongation, respectively denoted MSA100 and MSA300. The reinforcement index is the ratio of modulus MSA300 to modulus MSA100.

The tensile measurements are carried out at a temperature of 60° C.±2° C. and under standard hygrometry conditions (50±5% relative humidity).

### Preparation of the Rubber Compositions:

An internal mixer having a volume of 3300 cm³ (end filling level: approximately 70% by volume), the initial vessel temperature of which is approximately 50° C., is successively charged with the elastomer, the reinforcing filler, where appropriate the plasticizing hydrocarbon resin, the secondary accelerators and also the various other ingredients, with the exception of the sulfur and the primary accelerator. Thermomechanical working (non-productive phase) is then carried out in a step lasting a total of approximately 3 to 4 min until a maximum dropping temperature of 160° C. is reached. The mixture thus obtained is recovered and cooled and then the sulfur and the primary accelerator are incorporated on an external mixer (open mill) at 30° C., everything being mixed (productive phase) for 10 minutes.

The breakdown of the formulations of the compositions is given in Table 1.

The compositions thus obtained are subsequently calendered, either in the form of plates (with a thickness ranging from 2 to 3 mm) or thin sheets of rubber, for the measurement of their physical or mechanical properties after vulcanization at 140° C. (cured state), or in the form of profiled elements that can be used directly, after cutting and/or assembling to the desired dimensions, for example as semifinished products for tires.

The copolymer of ethylene and 1,3-butadiene, elastomer E1, is synthesized according to the procedure described below in the presence of a catalyst system containing a neodymium metallocene and an organomagnesium in an Mg/Nd molar ratio of 2.2. The polymerization being carried out with an Mg/Nd molar ratio greater than 2.2, BOMAG is added to the polymerization medium.

All the reagents are obtained commercially, except for the metallocene, which can be prepared according to the procedure described in document WO 2007054224. The butyloctylmagnesium BOMAG (20% in heptane, C=0.88 mol·L⁻¹) is obtained from Chemtura and is transferred to and then stored in a Schlenk tube under an inert atmosphere. The ethylene, of N35 grade, is obtained from Air Liquide and is used without prior purification.

The catalyst system is a preformed catalyst system. It is prepared in methylcyclohexane from a metallocene, [Me₂Si(Flu)₂Nd(μ-BH₄)₂Li(THF)], at 0.0065 mol/L, a cocatalyst, butyloctylmagnesium (BOMAG), the BOMAG/Nd molar ratio of which is equal to 2.2, and a preformation monomer, 1,3-butadiene, the 1,3-butadiene/Nd molar ratio of which is equal to 90. The medium is heated at 80° C. over a period of 5 h. It is prepared by a method of preparation according to section II.1 of patent application WO 2017093654 A1.

The ethylene and the 1,3-butadiene are polymerized according to a continuous process in solution in methylcyclohexane at 80° C. and 10 bar, in the presence of a catalyst system (81 μmol Nd per 100 g of monomers), the mass concentration of monomer feed into the reactor being 6%, the 1,3-butadiene/ethylene mass ratio being 0.5, the active Mg/Nd molar ratio being 4.

At the desired conversion (71%) for achieving an Mn of about 160 000 g/mol, the polymerization is stopped at the line outlet using a solution of antioxidants in methylcyclohexane (1 phr of N-(1,3-dimethylbutyl)-N′-phenyl-p-phenylenediamine and 0.9 phr of 2,2′-methylenebis(4-methyl-6-tert-butylphenol); phr=parts by weight per hundred parts by weight of elastomer). The copolymer is recovered by a steam distillation process termed stripping that is well known to those skilled in the art, and is then dried on an endless screw machine equipped with a single screw.

The copolymer contains 74% of ethylene units, 7% of 1,2 units, 12% of 1,4 units (of which more than 80% is 1,4-trans) and 7% of cyclic units (1,2-cyclohexane units), the percentages being molar. Its transition temperature is −44° C. (ΔT of 7° C., ΔT being the temperature difference between the start and end of the glass transition), its Mn is 154 516 g/mol (PI 1.70), and its ML (1+4) at 100° C. is 65.

### Results

The results are given in Table 2. The results are expressed in base 100 relative to a control ([value of test composition/value of control composition]×100). A value greater than 100 indicates a value greater than that of the control.

Compositions C1 to C3, which contain a highly saturated diene elastomer, a carbon black and a polyalkylene glycol, in this case a polyethylene glycol, are all inventive. Composition C0, which differs from compositions C1 to C3 in that it does not contain a polyalkylene glycol, is a control composition for C1 to C3.

Table 2 shows that adding the polyalkylene glycol to a rubber composition reinforced with a carbon black and containing a highly saturated diene elastomer significantly increases tear resistance performance: Moreover, these gains are obtained with a level of reinforcement of the same order of magnitude as that of the control composition C0. The best results are obtained for rubber compositions in which the polyalkylene glycol content is greater than 0.2 phr.

TABLE 1

| Composition | C0 | C1 | C2 | C3 |
|---|---|---|---|---|
| EBR (1) | 100 | 100 | 100 | 100 |
| Carbon black (2) | 40 | 40 | 40 | 40 |
| Anti-ozone wax (3) | 1 | 1 | 1 | 1 |
| Antioxidant (4) | 2 | 2 | 2 | 2 |
| Stearic acid (5) | 1.5 | 1.5 | 1.5 | 1.5 |
| ZnO (6) | 2.5 | 2.5 | 2.5 | 2.5 |
| PEG (7) | — | 0.2 | 0.6 | 1.2 |
| Accelerator (8) | 0.9 | 0.9 | 0.9 | 0.9 |
| Sulfur | 0.9 | 0.9 | 0.9 | 0.9 |

(1) Elastomer E1
(2) Carbon black N234 (BET 120 m²/g)
(3) Anti-ozone wax, “Varazon 4959” from Sasol Wax
(4) N-(1,3-Dimethylbutyl)-N′-phenyl-p-phenylenediamine, “Santoflex 6PPD” from Flexys
(5) Stearin, “Pristerene 4931” from Uniqema
(6) Zinc oxide, industrial grade, from Umicore
(7) Polyethylene glycol, “Carbowax 8000” from Dow Corning
(8) N-Cyclohexyl-2-benzothiazylsulfenamide, “Santocure CBS” from Flexys

TABLE 2

| Composition | C0 | C1 | C2 | C3 |
|---|---|---|---|---|
| Tear strength | 100 | 265 | 401 | 401 |
| Reinforcement index | 100 | 100 | 102 | 102 |

What is claimed is:

1. A rubber composition comprising more than 90 phr of a highly saturated diene elastomer that is a copolymer of ethylene and 1,3-butadiene and that contains more than 50 mol % of ethylene units, between 30 phr and 55 phr of a reinforcing filler that comprises more than 90% by weight of a carbon black, a vulcanization system and a content of less than 3 phr of a polyalkylene glycol bearing a hydroxy function at either end of the polymer chain, the polyalkylene glycol being a homopolymer of ethylene glycol or propylene glycol or a copolymer of ethylene glycol and propylene glycol.

2. The rubber composition according to claim 1, wherein the highly saturated diene elastomer comprises at least 60 mol % of ethylene units.

3. The rubber composition according to claim 1, wherein the highly saturated diene elastomer comprises at most 80 mol % of ethylene units.

4. The rubber composition according to claim 1, wherein the highly saturated diene elastomer is a statistical copolymer.

5. The rubber composition according to claim 1, wherein the content of polyalkylene glycol is less than 2 phr.

6. The rubber composition according to claim 1, wherein the content of polyalkylene glycol is greater than 0.2 phr.

7. The rubber composition according to claim 1, wherein the polyalkylene glycol is a polyethylene glycol.

8. The rubber composition according to claim 1, wherein the content of reinforcing filler ranges from 35 phr to 50 phr.

9. The rubber composition according to claim 1, wherein the carbon black represents more than 95% by weight of the reinforcing filler.

10. The rubber composition according to claim 1, wherein the carbon black represents 100% by weight of the reinforcing filler.

11. The rubber composition according to claim 1, wherein the polyethylene glycol has a weight-average molar mass of between 2000 and 20 000 g/mol.

12. The rubber composition according to claim 1, wherein the polyalkylene glycol has a weight-average molar mass of between 5000 and 10 000 g/mol.

13. The rubber composition according to claim 1, wherein the content of the highly saturated diene elastomer is greater than 95 phr.

14. The rubber composition according to claim 1, wherein the content of the highly saturated diene elastomer is equal to 100 phr.

15. A tire comprising a tread in which the portion intended to be in contact with the road surface consists wholly or partly of a rubber composition as defined in claim 1.

16. The rubber composition according to claim 2, wherein the highly saturated diene elastomer comprises at least 65 mol % of ethylene units.

17. The rubber composition according to claim 3, wherein the highly saturated diene elastomer comprises at most 75 mol % of ethylene units.

18. The rubber composition according to claim 8, wherein the content of reinforcing filler ranges from 35 phr to 45 phr.
